(19) United States
(12) Patent Application Publication
(10) Pub. No.: US 2017/0075136 A1
(43) Pub. Date: Mar. 16, 2017

(54) DEHYDRATED CONTACT LENS

(71) Applicant: MICRO CONTACT, LLC, Leesburg, VA (US)

(72) Inventor: Keith Smithson, Leesburg, VA (US)

(73) Assignee: MICRO CONTACT, LLC, Leesburg, VA (US)

(21) Appl. No.: 15/156,666

(22) Filed: May 17, 2016

Related U.S. Application Data
(60) Provisional application No. 62/136,304, filed on Mar. 20, 2015.

(51) Int. Cl. G02C 7/04

(52) U.S. Cl. CPC G02C 7/049

(57) ABSTRACT

A contact lens in a reduced state and an expanded state is provided. The reduced state includes a parabola shape and has a diameter of about 6 mm up to about 11 mm. The reduced state may be reduced in size due to dehydration. The reduced state is capable of absorbing a liquid and expanding to an expanded state. The expanded state includes a diameter of about 12 mm up to about 15 mm and maintains the parabola shape of the reduced state.

### CROSS-REFERENCE TO RELATED APPLICATION

This application claims the benefit of priority of U.S. provisional application No. 62/136,304, filed Mar. 20, 2015, the contents of which are herein incorporated by reference.

### BACKGROUND OF THE INVENTION

The present invention relates to contact lenses and, more particularly, to a smaller diameter contact lens.

A contact lens is a thin lens placed directly on the surface of the eye. Contact lenses are considered medical devices and can be worn to correct vision, or for cosmetic or therapeutic reasons. In America alone greater than 150 million persons use corrective eyewear, yet only 36 million Americans wear contact lenses. According to Eyehealth web, the most common factors for avoiding contact lens use are fear of insertion, fear of removal, fear of feeling something in the eye, or difficulty in attempted insertion.

As can be seen, there is a need for smaller contact lenses to appeal to a greater amount of the visually impaired.

### SUMMARY OF THE INVENTION

In one aspect of the present invention, an apparatus comprises: a contact lens comprising a parabola shape and comprising a diameter of about 6 mm up to about 11 mm, wherein the contact lens is capable of absorbing a liquid and expanding to an expanded state comprising a diameter of about 12 mm up to about 15 mm, wherein the expanded state retains the parabola shape.

In another aspect of the present invention, a method of using a contact lens comprises: removing a contact lens from a liquid reservoir, wherein the contact lens comprises a diameter of about 12 mm up to about 15 mm; dehydrating the contact lens and thereby reducing the diameter of the contact lens to about 6 mm up to about 11 mm forming a dehydrated contact lens, wherein the dehydrated contact lens comprises a parabola shape.

These and other features, aspects and advantages of the present invention will become better understood with reference to the following drawings, description and claims.

### BRIEF DESCRIPTION OF THE DRAWINGS

FIG. 1 is a perspective view of an embodiment of the present invention illustrating a contact lens in a reduced state;

FIG. 2 is a perspective view of an embodiment of the present invention illustrating a contact lens in an expanded state; and

FIG. 3 is a perspective view of an embodiment of the present invention illustrating the reduced state contact lens being inserted onto a user's eye.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

The present invention includes a method of dehydrating contact lenses and thereby reducing the contact's diameter. The polymer forming the contact lens is dehydrated so that the contact lens maintains a consistent curvature. The lens then rehydrates on the eye to regain the diameter necessary for all day comfort and stability.

The present invention also includes a contact lens including a reduced diameter. The reduced diameter may be in between 6 mm up to 11 mm. Once the user places the smaller diameter contact lenses within the eye, the contact lens expands to a standard 14.0 mm diameter.

Currently, the average vertical visible iris diameter (VVID) of 130 patients is 10.5 mm+/−0.50 mm, per 2012 study in Journal of Optometry. The average human cornea is 11.8 mm. The average diameter of a soft disposable contact lens is 14.2 mm. Therefore, the eyelids need to be expanded via force to insert a soft contact lens. Since the present invention reduces the size to about 10 mm, the dehydrated lens is easily and comfortably inserted onto the eye. Lubricating drops may applied to the eyes or dehydrated lens prior to lens insertion, for adequate, rapid and comfortable rehydration.

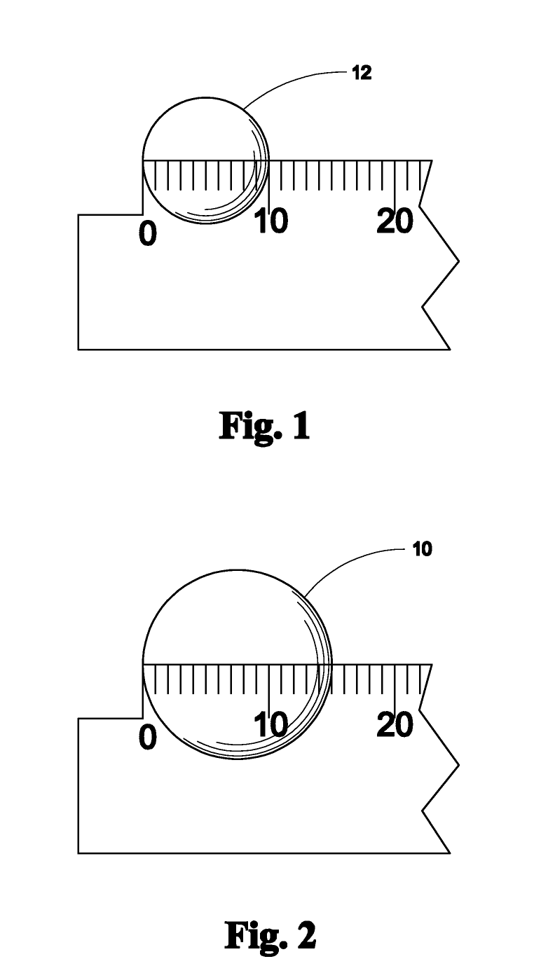

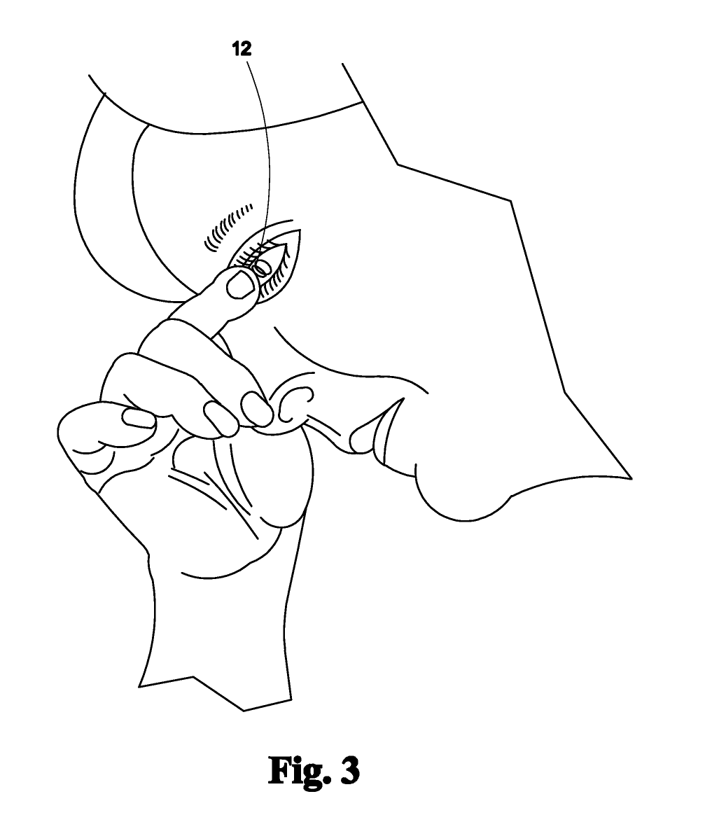

Referring to FIGS. 1 through 3, the present invention includes a contact lens 10, 12. The contact lens 10, 12 may be in a reduced state 12 and an expanded state 10. The reduced state 12 includes a parabola shape and has a diameter of about 6 mm up to about 11 mm. The reduced state 12 may be reduced in size by dehydration. The reduced state 12 is capable of absorbing a liquid and expanding to an expanded state 10. The expanded state 10 includes a diameter of about 12 mm up to about 15 mm and maintains the parabola shape of the reduced state 12.

The contact lens 10, 12 may be made of a polymer capable of absorbing and retaining liquid. In certain embodiments, the polymer is Nesofilcon A. Nesoflicon A is a hydrophilic copolymer of 2-hydroxyethyl methacrylate and N-vinyl pyrrolidone. However, any type of contact lens that maintains curvature while being dehydrated may be used.

As mentioned above, the reduced state 12 may include a diameter of about 6 mm up to about 11 mm. For example, the reduced state 12 may include a diameter of about 9 mm up to about 10 mm. As mentioned above, the expanded state 10 may include a diameter of about 12 mm up to about 15 mm. For example, the expanded state 10 may include a diameter of about 13 mm up to about 15 mm, such as about 14 mm.

A method of reducing a contact lens in diameter and using the contact lens may include the following steps: removing a hydrated contact lens from a liquid reservoir, wherein the hydrated contact lens has a diameter of about 12 mm up to about 15 mm; dehydrating the hydrated contact lens and thereby reducing the diameter of the contact lens to about 6 mm up to about 11 mm forming a dehydrated contact lens, wherein the dehydrated contact lens has a parabola shape. The parabola shape of the dehydrated contact lens may include the same or substantially similar parabola shape of the hydrated contact lens.

The method of the present invention may further include the step of: inserting the dehydrated contact lens onto an eye, wherein liquid of the eye rehydrates the dehydrated contact lens and the dehydrated contact lens expands to a diameter of about 12 mm up to about 15 mm. However, in certain embodiments, a lubricating liquid may be used to aid the contact lens in expanding. In such embodiments, the method of the present invention may further include the step of: placing at least one lubricating drop on the eye and/or placing at least one lubricating drop onto the dehydrated contact lens prior to the step of inserting the dehydrated contact lens onto the eye. The pre insertion hydrating agent or lubricating eye drop may be Systane Ultra OTC®.

In certain embodiments, the step of dehydrating the contact lens may include the step of: placing the contact lens in an environment comprising a temperature of about 60° up to about 85° for a period of time from about 30 minutes up to about an hour. The contact lens is dehydrated on a sterile surface for a defined period of time. Alternately, the contact lens may be dehydrated in an oven with elevated temperatures for a shorter period of time. A user may then add a rehydration drop to their eye or lens and then insert the dehydrated contact lens into the eye and keep the eye closed for 30 seconds after insertion for full rehydration.

### Example

A Bausch and Lomb Biotrue One Day® disposable soft contact lens was used in this Example. The contact lens was removed from a solution. The diameter of the lens was measured immediately after removing the contact lens from the solution (hydrated) at about 15 mm. The lens was allowed to dry on a sterile surface at room temperature for about 1 hour until the lens was substantially dehydrated. The diameter of the dehydrated lens was measured at about 10.2 mm. The lens of the present invention had about a 50% reduction in diameter and maintained a parabola shape of the hydrated lens. The dehydrated lens was inserted into an eye and the contact lens rehydrated and expanded, which is important because the average human cornea is 12.8 mm. The soft contact lens covered the cornea for optimum comfort and stability.

It should be understood, of course, that the foregoing relates to exemplary embodiments of the invention and that modifications may be made without departing from the spirit and scope of the invention as set forth in the following claims.

What is claimed is:

1. An apparatus comprising:
a contact lens comprising a parabola shape and comprising a diameter of about 6 mm up to about 11 mm, wherein
the contact lens is capable of absorbing a liquid and expanding to an expanded state comprising a diameter of about 12 mm up to about 15 mm, wherein the expanded state retains the parabola shape.

2. The apparatus of claim 1, wherein the contact lens is made of a polymer.

3. The apparatus of claim 2, wherein the polymer is a hydrophilic copolymer comprising 2-hydroxyethyl methacrylate and N-vinyl pyrrolidone.

4. The apparatus of claim 1, wherein the contact lens comprises a diameter of about 9 mm up to about 10 mm.

5. The apparatus of claim 1, wherein the expanded state comprises a diameter of about 13 mm up to about 15 mm.

6. The apparatus of claim 1, wherein the expanded state comprises a diameter of about 14 mm.

7. The apparatus of claim 1, wherein the contact lens is substantially dehydrated.

8. A method of using a contact lens comprising:
removing a contact lens from a liquid reservoir, wherein the contact lens comprises a diameter of about 12 mm up to about 15 mm;
dehydrating the contact lens and thereby reducing the diameter of the contact lens to about 6 mm up to about 11 mm forming a dehydrated contact lens, wherein
the dehydrated contact lens comprises a parabola shape.

9. The method of claim 8, further comprising the step of:
inserting the dehydrated contact lens onto an eye, wherein liquid of the eye rehydrates the dehydrated contact lens and the dehydrated contact lens expands to a diameter of about 12 mm up to about 15 mm.

10. The method of claim 9, further comprising the step of:
placing at least one lubricating drop onto the dehydrated contact lens prior to the step of inserting the dehydrated contact lens onto the eye.

11. The method of claim 9, further comprising the step of:
placing at least one lubricating drop on the eye prior to the step of inserting the dehydrated contact lens onto the eye.

12. The method of claim 8, wherein the step of dehydrating the contact lens comprises placing the contact lens in an environment comprising a temperature of about 60° up to about 85° for a period of time from about 30 minutes up to about an hour.

13. The method of claim 8, wherein the contact lens is made of a polymer.

14. The method of claim 13, wherein the polymer is a hydrophilic copolymer comprising 2-hydroxyethyl methacrylate and N-vinyl pyrrolidone.

15. The method of claim 8, wherein the dehydrated contact lens comprises a diameter of about 9 mm up to about 10 mm.

16. The method of claim 8, wherein the contact lens comprises a diameter of about 13 mm up to about 15 mm.

17. The method of claim 8, wherein the contact lens comprises a diameter of about 14 mm.
